(19) United States
(12) Patent Application Publication
(10) Pub. No.: US 2011/0320039 A1
(43) Pub. Date: Dec. 29, 2011

(54) ROBOT CALIBRATION SYSTEM AND CALIBRATING METHOD THEREOF

(75) Inventors: YUAN-CHE HSU, Tu-Cheng (TW); DU-XUE ZHANG, Shenzhen City (CN); SHUI-PING WEI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/053,468

(22) Filed: Mar. 22, 2011

(30) Foreign Application Priority Data
Jun. 25, 2010 (CN) 201010209872.0

(51) Int. Cl. B25J 13/08; B25J 9/02

(52) U.S. Cl. 700/254; 901/47; 901/2

(57) ABSTRACT

A robot calibration system includes a robot, a calibration tool, a plane calibration board, a camera, and a controller. The calibration tool is assembled to the robot and is controlled by the robot to move along a preset trajectory. The plane calibration board is located under the calibration tool and has a plurality of characteristic corner points on one surface thereof. The camera is configured for capturing an image of the plane calibration board. The controller electrically connects with the robot and the camera respectively, the controller predefines a preset control program for controlling the robot and the camera to operate, and the controller is configured for calibrating the robot. The disclosure also discloses a method for calibrating a robot for use with a robot calibration system.

### BACKGROUND

1. Technical Field

The present disclosure generally relates to the field of robotic position calibration, and particularly, to a robot calibration system and a calibrating method thereof.

2. Description of Related Art

Robotic position calibration is a problem found in automation systems using robots. The most common calibration of the desired positions for robots is done manually by an expert in the field. However, manual calibration is dependent upon the visual acuity of the skilled expert. Furthermore, manual calibration is time-consuming, costly and inconsistent. Sometimes tool geometry makes accurate observations of robot motions difficult or impossible.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the robot calibration system and calibrating method thereof. Moreover, in the drawings like reference numerals designate corresponding parts throughout the several views. Wherever possible, the same reference numerals are used throughout the drawings to refer to the same or like elements of an embodiment.

FIG. 1 is a schematic view of one embodiment of a robot calibration system, showing the layout of the robot calibration system.

FIG. 2 shows a plan view of a plane calibration board of the robot calibration system.

FIG. 3 is a flow chart of a calibrating method of the robot calibration system.

FIG. 4 shows a schematic view of a calibration tool moving on the plane calibration board.

### DETAILED DESCRIPTION

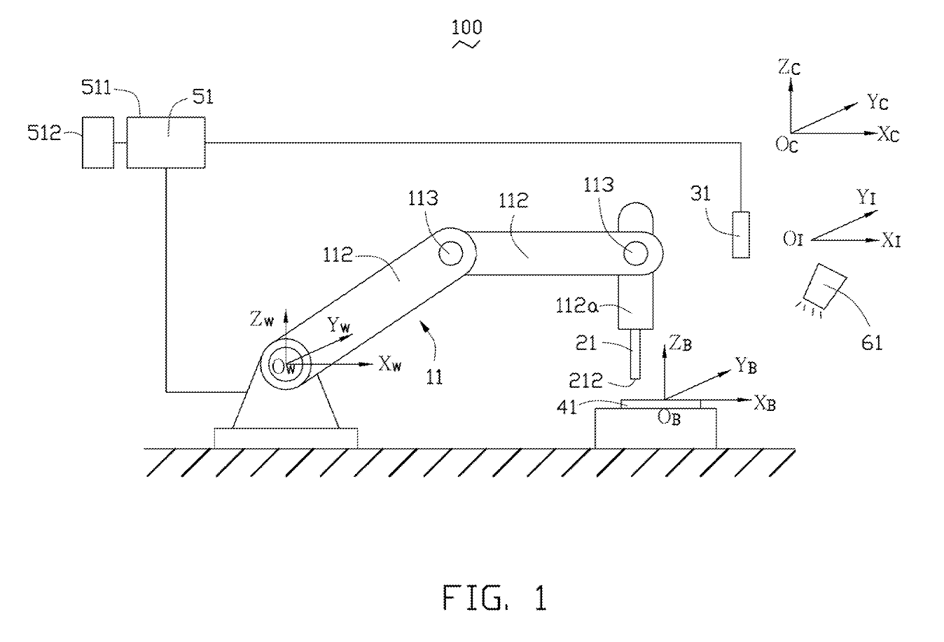

Referring to FIG. 1, a robot calibration system 100 includes a robot 11, a calibration tool 21, a camera 31, a plane calibration board 41 located within a field angle of the camera 31, a controller 51 and a light source 61. The robot calibration system 100 defines a robot base coordinate system {W}, a camera coordinate system {C}, an imaging coordinate system {I}, and a calibration board coordinate system {B}.

The robot base coordinate system {W} is established based on the robot 11 and consists of an origin O_{W}, a first coordinate axis O_{W}X_{W}, a second coordinate axis O_{W}Y_{W} perpendicular to the first coordinate axis O_{W}X_{W}, and a third coordinate axis O_{W}Z_{W} perpendicular to the first coordinate axis O_{W}X_{W} and the second coordinate axis O_{W}Y_{W}. The camera coordinate system {C} is established based on the camera 31 and consists of an origin O_{C}, a first coordinate axis O_{C}X_{C}, a second coordinate axis O_{C}Y_{C} perpendicular to the first coordinate axis O_{C}X_{C}, and a third coordinate axis O_{C}Z_{C} perpendicular to the first coordinate axis O_{C}X_{C} and the second coordinate axis O_{C}Y_{C}. The imaging coordinate system {I} is established based on a plane image captured by the camera 31 and consists of an origin O_{I}, a first coordinate axis O_{I}X_{I}, and a second coordinate axis O_{I}Y_{I} perpendicular to the first coordinate axis O_{I}X_{I}. The first coordinate axis O_{I}X_{I} and the second coordinate axis O_{I}Y_{I} of the imaging coordinate system {I} are respectively parallel to the corresponding first and second coordinate axes O_{C}X_{C}, O_{C}Y_{C} of the camera coordinate system {C}.

The calibration board coordinate system {B} is established based on the plane calibration board 41 and consists of an origin O_{B}, a first coordinate axis O_{B}X_{B}, a second coordinate axis O_{B}Y_{B} perpendicular to the first coordinate axis O_{B}X_{B}, and a third coordinate axis O_{B}Z_{B} perpendicular to the first coordinate axis O_{B}X_{B}, and second coordinate axis O_{B}Y_{B}. In the illustrated embodiment, the plane calibration board 41 defines a plurality of grids 410 on one surface thereof. The origin O_{B} of the plane calibration board 41 is defined at one characteristic corner point 411 of one of the grids 410. Two adjacent edges of the corresponding grid 410 are defined as the first and second coordinate axes O_{B}X_{B}, O_{B}Y_{B}. The corresponding third coordinate axis O_{B}Z_{B} can be obtained via the right-hand rule.

The robot 11 includes a plurality of mechanical arms 112 connecting with each other in series via a plurality of joints 113. Each joint 113 is equipped with a displacement sensor, such as a rotary encoder, for sensing the rotary angle of the corresponding mechanical arm 112.

The calibration tool 21 is fixedly assembled to a distal end of the mechanical arm 112a and is controlled by the mechanical arm 112a to move along a preset trajectory. The calibration tool 21 can be a slender calibration rod and includes a contactor 212.

The camera 31 is mounted to a fixing bracket and positioned away from the robot 11. The camera 31 is configured for capturing or shooting the image of the plane calibration board 41.

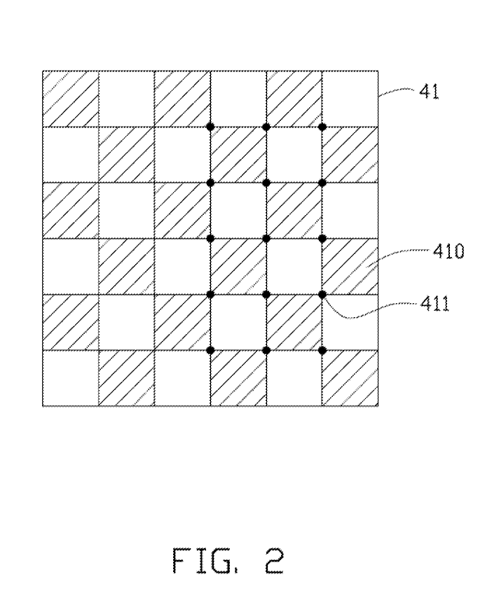

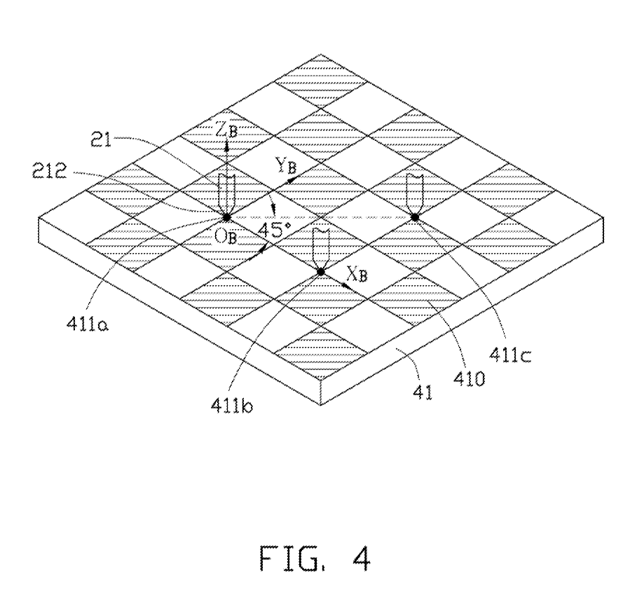

Also referring to FIGS. 2 and 4, the plane calibration board 41 is positioned adjacent to the robot 11 and located under the calibration tool 21. The plane calibration board 41 is a checkerboard in the illustrated embodiment. The plane calibration board 41 defines a plurality of rectangular grids 410 arranged in matrix on one surface thereof. All the grids 410 have substantially the same shape as each other. Each grid 410 has four characteristic corner points 411.

The controller 51 is electrically connected with the robot 11 and the camera 31, respectively. The controller 51 predefines a preset control program (not shown) installed therein for controlling the robot 11 and the camera 31 to operate. The controller 51 is configured for obtaining the image information captured by the camera 31, calibrating and storing the internal parameters and external parameters of the camera 31; processing and analyzing the image information to acquire the conversion relationship between the imaging coordinate system {I} and the calibration board coordinate system {B}. The controller 51 is also configured for storing a moving trajectory of the calibration tool 21 based on the robot base coordinate system {W} and deducing the conversion relationship between the robot base coordinate system {W} and the calibration board coordinate system {B}, and finally deducing the conversion relationship between the imaging coordinate system {I} and the robot base coordinate system {W}. The controller 51 further includes a monitor 511 and a teaching device 512. The monitor 511 is configured for displaying the program interface, a moving trajectory of the calibration tool and an operation to the teaching device 512. The teaching device 512 is configured for demonstrating, guiding and controlling the robot 11 to move in accordance with a preset trajectory.

The light source 61 is positioned aside of the plane calibration board 41 for illuminating the plane calibration board 41 and enhancing the brightness of the plane calibration board 41.

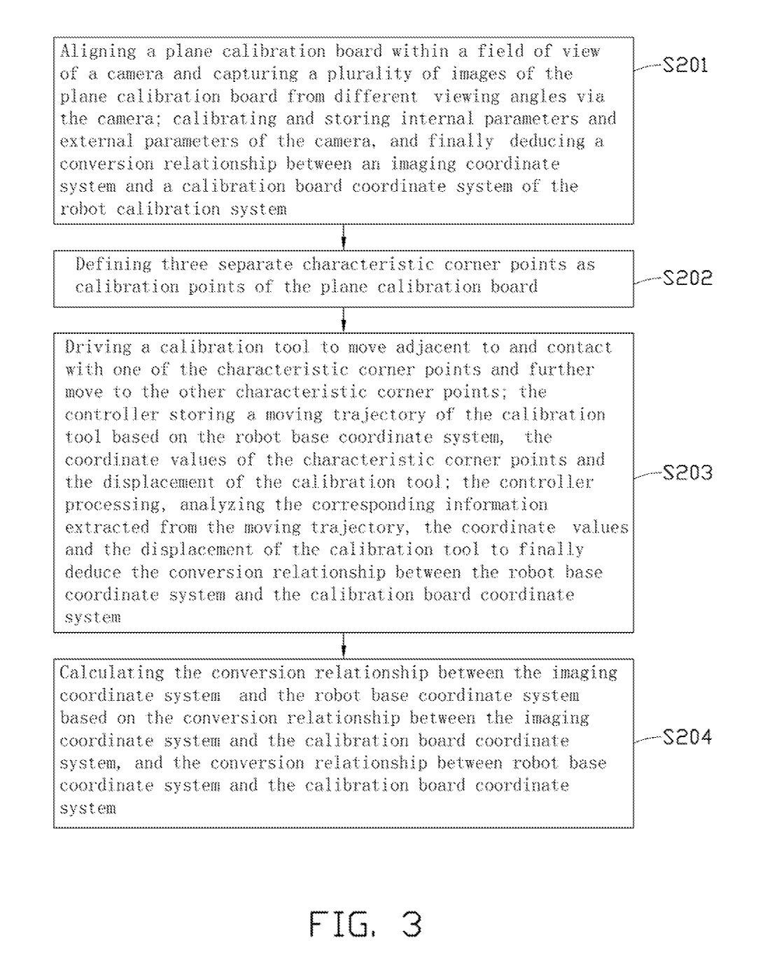

Also referring to FIG. 3, a method for calibrating a robot for use with the robot calibration system 100 includes the following steps:

S201: the plane calibration board 41 is aligned within the field of view of the camera 31 and a plurality of images of the plane calibration board 41 are captured from different viewing angles via the camera 31; meanwhile, the controller 51 is calibrating and storing the internal parameters and external parameters of the camera 31, and finally deducing the conversion relationship between the imaging coordinate system {I} and the calibration board coordinate system {B} of the robot calibration system 100 is deduced. In the illustrated embodiment, a method of the controller 51 to calibrate the internal parameters and external parameters of the camera 31 is using the flexible camera calibration method by viewing a plane from unknown orientations (ICCV' 99, Corfu, Greece, 1999. 666˜673). In this embodiment, the method for calibrating the internal parameters and external parameters of the camera 31 includes the following steps: a plurality of flat-images of the plane calibration board 41 are captured from different viewing angles via the camera 31; wherein, each flat-image is taken by capturing the image of nine characteristic corner points 411 of the plane calibration board 41, which consists of a 3×3 matrix arrangement of the characteristic corner points 411. The controller 51 then processes and analyzes the image information via the preset control program to acquire the corresponding internal and external parameters of the camera 31. The internal parameters of the camera 31 form a transformation matrix A, and the external parameters of the camera 31 form a rotation matrix R₁ and a translation matrix T₁. Thus, the conversion relationship between the imaging coordinate system {I} and the calibration board coordinate system {B} can be expressed in the following equation:

I=A[R₁ T₁]B (1).

In addition, in step S201, the controller 51 can be set to extract and analyze the distortion coefficient of the camera 31 to determine whether to adjust the focus or to replace by another camera 31. In this embodiment, when the distortion coefficient of the camera 31 is greater than a default value, the focal length of the camera 31 needs to be adjusted or the camera needs to be replaced.

S202: three characteristic corner points 411a, 411b, 411c, are defined as the calibration points of the plane calibration board 41. In the illustrated embodiment, the characteristic corner point 411a is defined as the origin O_{B} of the calibration board coordinate system {B}. The line O_{B} 411c formed by the origin O_{B} and the characteristic corner point 411c forms an angle of 45 degrees with the line O_{B} 411b formed by the origin O_{B} and the characteristic corner point 411b. In this embodiment, the line O_{B} 411b coincides with the first coordinate axis O_{B}X_{B} of the calibration board coordinate system {B}, and the characteristic corner point 411c is positioned in the first quadrant.

S203: the teaching device 512 is operated to control and guide the robot 11 to work, the contactor 212 of the calibration tool 21 is driven to move adjacent to and contact with one of the characteristic corner points 411 (namely the characteristic corner point 411a in the illustrated embodiment) and further move to the other characteristic corner points 411 (namely the other two characteristic corner points 411b and 411c). Meanwhile, the controller 51 stores the moving trajectory of the calibration tool 21 based on the robot base coordinate system {W}, the coordinate values of the characteristic corner points 411 (namely the three characteristic corner points 411a, 411b and 411c) and the displacement of the calibration tool 21. The controller 51 further processes and analyzes the corresponding information extracted from the moving trajectory of the calibration tool 21, the coordinate values of the characteristic corner points 411 and the displacement of the calibration tool 21 to finally deduce the conversion relationship between the robot base coordinate system {W} and the calibration board coordinate system {B}. In the illustrated embodiment, if the rotation matrix and translation matrix of the calibration board coordinate system {B} relative to the robot base coordinate system {W} are respectively R₂ and T₂, we can then express the relation between the two rotation matrix R₂ and translation matrix T₂ is to be the following equation:

W=[R₂ T₂]B (2).

S204: the conversion relationship between the imaging coordinate system {I} and the robot base coordinate system {W} are calculated based on the conversion relationship between the imaging coordinate system {I} and the calibration board coordinate system {B}, and the conversion relationship between the robot base coordinate system {W} and the calibration board coordinate system {B}. In the illustrated embodiment, the transformation matrix A, the rotation matrix R₁ and the translation matrix T₁ can be obtained from step S201, the rotation matrix R₂ and translation matrix T₂ can be obtained from step S203, and thus, the conversion relationship between the imaging coordinate system {I} and the robot base coordinate system {W} can finally be express as the following equation:

W=[R₂ T₂][R₁ T₁]⁻¹A⁻¹I (3).

The above method for calibrating a robot is simple, and it is easy to operate. It is to be understood that the above method for calibrating a robot could further include a step for checking the conversion relationship between the imaging coordinate system {I} and the robot base coordinate system {W} via image matching technology.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A robot calibration system, comprising:
a robot;
a calibration tool assembled to the robot and controlled by the robot to move along a preset trajectory;
a plane calibration board located under the calibration tool and having a plurality of characteristic corner points on one surface thereof;
a camera for capturing one or more images of the plane calibration board; and
a controller electrically connecting with the robot and the camera, respectively, the controller predefining a preset control program for controlling the robot and the camera to operate and the controller configured for calibrating the robot.

2. The robot calibration system of claim 1, wherein the robot calibration system defines a robot base coordinate system established based on the robot, a camera coordinate system established based on the camera, an imaging coordinate system established based on a plane image captured by the camera, and a calibration board coordinate system established based on the plane calibration board; the controller is configured for obtaining the image information captured by the camera, calibrating and storing the internal parameters and external parameters of the camera; processing and analyzing the image information to acquire the conversion relationship between the imaging coordinate system and the calibration board coordinate system.

3. The robot calibration system of claim 2, wherein the controller is further configured for storing a moving trajectory of the calibration tool based on the robot base coordinate system and deducing the conversion relationship between the robot base coordinate system and the calibration board coordinate system, and deducing the conversion relationship between the imaging coordinate system and the robot base coordinate system.

4. The robot calibration system of claim 1, wherein the controller further comprises a monitor for displaying the program interface, and a moving trajectory of the calibration tool.

5. The robot calibration system of claim 4, wherein the controller further comprises a teaching device for demonstrating, guiding and controlling the robot to move in accordance with a preset trajectory.

6. The robot calibration system of claim 1, wherein the plane calibration board is positioned adjacent to the robot, the robot comprises a plurality of mechanical arms connecting with each other in series via a plurality of joints, and the calibration tool is fixedly assembled to a distal end of the mechanical arm.

7. The robot calibration system of claim 6, wherein each joint is equipped with a displacement sensor for sensing the rotary angle of the corresponding mechanical arm.

8. The robot calibration system of claim 6, wherein the calibration tool is a slender calibration rod and includes a contactor, and the camera is mounted to a fixing bracket and positioned away from the robot.

9. The robot calibration system of claim 1, wherein the plane calibration board is a checkerboard, the plurality of grids are arranged in matrix on one surface of the plane calibration board, and each grid has four characteristic corner points.

10. The robot calibration system of claim 1, wherein the robot calibration system further includes a light source positioned aside of the plane calibration board for illuminating the plane calibration board and enhancing the brightness of the plane calibration board.

11. A method for calibrating a robot for use with a robot calibration system, the robot calibration system comprising a robot, a calibration tool controlled by the robot, a plane calibration board, a camera and a controller, the method comprising:
aligning the plane calibration board within a field of view of the camera and capturing a plurality of images of the plane calibration board from a plurality of different viewing angles via the camera; the controller calibrating and storing the internal parameters and the external parameters of the camera, and deducing the conversion relationship between an imaging coordinate system and a calibration board coordinate system of the robot calibration system;
defining three characteristic corner points as the calibration points of the plane calibration board;
driving the calibration tool to move adjacent to and contact with one of the characteristic corner points and further move to the other characteristic corner points; the controller storing the moving trajectory of the calibration tool, the coordinate values of the characteristic corner points and the displacement of the calibration tool; the controller processing, analyzing and deducing the conversion relationship between a robot base coordinate system and the calibration board coordinate system; and
calculating the conversion relationship between the imaging coordinate system and the robot base coordinate system.

12. The method for calibrating a robot of claim 11, wherein a method for the controller to calibrate the internal parameters and external parameters of the camera is using the flexible camera calibration method by viewing a plane from unknown orientations.

13. The method for calibrating a robot of claim 12, wherein the method for calibrating the internal parameters and external parameters of the camera comprises following steps: capturing a plurality of flat-images of the plane calibration board from the different viewing angles via the camera; the controller processing and analyzing the image information to acquire the corresponding internal and external parameters of the camera and deducing the conversion relationship between an imaging coordinate system and a calibration board coordinate system of the robot calibration system.

14. The method for calibrating a robot of claim 13, wherein the plane calibration board comprises a plurality of characteristic corner points defined on one surface thereof, each grid has four characteristic corner points; each flat-image is taken by capturing the image of nine characteristic corner points of the plane calibration board which consists of 3×3 matrix arrangements of the characteristic corner points.

15. The method for calibrating a robot of claim 13, wherein the method further comprises a step for driving the controller to extract and analyze the distortion coefficient of the camera to determine whether to adjust the focus of the camera or to replace by another camera.

16. The method for calibrating a robot of claim 13, wherein the method further comprises a step for checking the conversion relationship between the imaging coordinate system and the robot base coordinate system via image matching technology.
